(19) United States
(12) Patent Application Publication
(10) Pub. No.: US 2024/0001775 A1
(43) Pub. Date: Jan. 4, 2024

(54) APPARATUS AND METHOD FOR REDUCING JERK AFTER AN ELECTRIC VEHICLE STOPS

(71) Applicants: HYUNDAI MOTOR COMPANY, Seoul (KR); KIA CORPORATION, Seoul (KR)

(72) Inventor: Ji Won Oh, Hwaseong-si (KR)

(73) Assignees: HYUNDAI MOTOR COMPANY, Seoul (KR); KIA CORPORATION, Seoul (KR)

(21) Appl. No.: 18/074,137

(22) Filed: Dec. 2, 2022

(30) Foreign Application Priority Data
Jun. 30, 2022 (KR) 10-2022-0080130

(51) Int. Cl. B60L 15/20

(52) U.S. Cl. CPC B60L 15/2009; B60L 2240/14; B60L 2250/26; B60L 2240/461; B60L 2240/423; B60L 2240/486; B60L 2240/12; B60L 2240/80; B60L 2240/421

(57) ABSTRACT

An apparatus and a method reduce a jerk phenomenon of an electric vehicle occurring immediately after the electric vehicle is stopped. The method of reducing a stop jerk of an electric vehicle includes acquiring vehicle state information through a vehicle state detection part and determining whether the vehicle reaches a stop completion state based on the acquired vehicle state information. The method includes, when it is determined that the vehicle reaches the stop completion state, determining and generating a torque command for jerk reduction to offset and reduce a vehicle jerk immediately after the stop based on vehicle acceleration information detected by an acceleration sensor and includes controlling an operation of a driving motor according to the generated torque command for jerk reduction. The apparatus for reducing a stop jerk performs the method.

### CROSS-REFERENCE TO RELATED APPLICATION

This application claims under 35 U.S.C. § 119(a) the benefit of priority to Korean Patent Application No. 10-2022-0080130 filed on Jun. 30, 2022, the entire contents of which are incorporated herein by reference.

### BACKGROUND

### (a) Technical Field

The present disclosure relates to an apparatus and a method for reducing a jerk after a stop of an electric vehicle, and more particularly, to an apparatus and a method for reducing a jerk after a stop of an electric vehicle, which reduce a jerk phenomenon of a vehicle occurring immediately after the stop.

### (b) Background Art

It is a well-known fact that a jerk phenomenon occurs as a vehicle body alternately leans forward and backward due to an occurrence of acceleration discontinuity at an instant when the vehicle is stopped and at an instant immediately after the stop.

In other words, when a driver operates a brake pedal to stop a vehicle, and when vehicle acceleration acts in a direction opposite to a driving direction due to vehicle deceleration resulting from braking, a vehicle body and the human body receive a force to be pulled in the driving direction due to an inertial force. In particular, at an instant when a tire is stopped on a road surface, the above phenomenon becomes more severe.

However, since the vehicle is an elastic body, a restoring force of the elastic body acts at an instant immediately after the tire is stopped on the road surface. Thus, the vehicle body and the human body are moved rearward and the jerk phenomenon occurs again at an instant when the vehicle body, which is pulled backward again in the action of the inertia force, returns to a front side toward the origin so that, after that, this phenomenon repeats for a short period of time.

The jerk phenomenon immediately after the stop is recognized as a negative effect in terms of ride comfort or convenience of the vehicle. Therefore, as a method of reducing the above jerk phenomenon, it is known to correct a braking force. Related Patent Documents, Korean Patent Application Laid-Open No. 10-2018-0057277 (May 30, 2018) and Korean Patent Application Laid-Open No. 10-2018-0096127 (Aug. 29, 2018) such methods.

However, all of the above methods, including those disclosed in the aforementioned Patent Documents, are to correct the braking force before a stop. Due to the braking force correction, an actual vehicle braking state may be different from braking desired by a driver. Thus, there may be a problem in that a different feeling occurs and these known methods cannot effectively respond to a jerk occurring after the vehicle is stopped.

In addition to the above methods, a method is known of preventing a vehicle jerk when parked and stopped by gradually reducing a braking force with respect to a vehicle wheel when a driver releases a brake pedal and then a parking brake is operated. A method is also known of operating a friction braking device according to an acceleration status of the vehicle immediately after the stop.

However, since a hydraulic pressure of a braking system should be controlled through valve control immediately after a stop, the above methods have clear limitations in terms of responsiveness and jerk reduction performance and a disadvantage of causing additional noise, vibration, harshness (NVH) problems.

### SUMMARY OF THE DISCLOSURE

The present disclosure has been made in an effort to solve the above-described problems associated with the prior art.

In one aspect, the present disclosure provides an apparatus and a method for effectively reducing a jerk phenomenon occurring immediately after stopping in an electrified vehicle that drives using a motor.

Objectives of the present disclosure are not limited to the above-described objectives. Other objectives of the present disclosure, which are not mentioned, should be understood by the following description and should be apparent through embodiments of the present disclosure.

In an embodiment, the present disclosure provides a method of reducing a jerk from stopping an electric vehicle. The method includes acquiring, by a controller, vehicle state information through a vehicle state detection part and determining, by the controller, whether a vehicle reaches a stop completion state after deceleration based on the acquired vehicle state information. When the controller determines that the vehicle reaches the stop completion state, the method includes determining and generating a torque command for jerk reduction to offset and reduce a vehicle jerk immediately after the stop based on vehicle acceleration information detected by an acceleration sensor of the vehicle state detection part. The method further includes controlling, by the controller, an operation of the driving motor according to the generated torque command for jerk reduction and offsetting and reducing the vehicle jerk due to a torque, which is output from the driving motor and applied to the vehicle.

In another embodiment, the present disclosure provides an apparatus for reducing a jerk from stopping an electric vehicle. The apparatus includes a vehicle state detection part configured to detect vehicle state information. When it is determined that a vehicle reaches a stop completion state after the vehicle is decelerated based on the vehicle state information acquired through the vehicle state detection part, a controller is configured to determine and generate a torque command for jerk reduction to offset and reduce a vehicle jerk immediately after the stop based on vehicle acceleration information detected by an acceleration sensor of the vehicle state detection part. A driving motor, as a part of the apparatus, is configured to be operated according to the torque command for jerk reduction output from the controller and configured to output a torque for offsetting and reducing the vehicle jerk and apply the torque to the vehicle.

Other aspects and embodiments of the present disclosure are discussed below.

It should be understood that the terms “vehicle” or “vehicular” or other similar term as used herein are inclusive of motor vehicles in general. Such motor vehicles may encompass passenger automobiles including sports utility vehicles (SUVs), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, such as for example, a vehicle that is both gasoline-powered and electric-powered.

The above and other features of the present disclosure are discussed below.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIG. 1 is a graph showing a measured result of acceleration of a vehicle in a longitudinal direction to indicate a general jerk motion occurring when the vehicle is stopped;

FIG. 2 is a block diagram illustrating a configuration of an apparatus for performing stop jerk reduction according to an embodiment of the present disclosure;

FIG. 3 is a flowchart illustrating a process of controlling a performance of the stop jerk reduction according to an embodiment of the present disclosure;

FIG. 4 is a diagram illustrating a stop jerk and a torque for jerk reduction in the present disclosure;

FIG. 5 is a diagram illustrating an example of a torque command for the jerk reduction to which an amplitude and an offset are applied to avoid a backlash torque region according to a gear stage state; and

FIG. 6 is a diagram illustrating an example of a jerk reduction effect when a stop jerk reduction function is applied according to the present disclosure.

It should be understood that the appended drawings are not necessarily to scale, presenting a somewhat simplified representation of various features illustrative of the basic principles of the present disclosure. The specific design features of the embodiments as disclosed herein, including, for example, specific dimensions, orientations, locations, and shapes will be determined in part by the particular intended application and use environment.

In the figures, the same reference numbers refer to the same or equivalent parts of the present disclosure throughout the several figures of the drawings.

### DETAILED DESCRIPTION

Hereinafter, embodiments of the present disclosure are described in detail with reference to the accompanying drawings. Specific structures or functional descriptions presented in the embodiments of the present disclosure are merely exemplified for the purpose of describing the embodiments according to the concept of the present disclosure, and the embodiments according to the concept of the present disclosure may be implemented in various forms. In addition, the embodiments are not to be taken in a sense, which limits the present disclosure to the specific embodiments, and should be construed to include modifications, equivalents, or substitutes within the spirit and technical scope of the present disclosure.

The terms first, second, and/or the like in the present disclosure may be used to describe various components, but the components are not to be limited by these terms. These terms may be used only for the purpose of distinguishing one component from another component. For example, a first component may be referred to as a second element, and similarly, the second component may also be referred to as the first component without departing from the scope of the present disclosure.

When a component is referred to as being “connected” or “coupled” to another component, it may be directly connected or coupled to another component, but it should be understood that still another component may be present between the component and the other component. On the contrary, when a component is referred to as being “directly connected to,” or “directly in contact with” another component, it should be understood that no other component is present between the component and another component. Other expressions describing the relationship between components, i.e., “between” and “immediately between,” or “adjacent to” and “directly adjacent to” should also be construed as described above.

Throughout the present specification, the same reference numerals indicate the same components. Terms used herein are for the purpose of describing the embodiments and are not intended to limit the present disclosure. In the present specification, the singular forms include the plural forms unless the context clearly dictates otherwise. It is noted that the terms “comprise” and/or “comprising”, “include” and/or “including”, “have” and/or “having”, and variations thereof used herein do not exclude the presence or addition of one or more other components, steps, operations, or elements in addition to stated components, steps, operations, or elements.

The present disclosure is mainly characterized in that an electric vehicle uses a torque of a driving motor for driving the electric vehicle to offset and reduce a jerk occurring when the electric vehicle is stopped and to minimize a different feeling that a driver may feel when the vehicle is stopped or stops. This improves riding comfort of the electric vehicle.

In the present disclosure, the “when stopped” at which a control process of reducing a jerk is performed may be defined as a period including a vehicle stop time at which a tire enters a state of being stopped and becomes fixed on a road surface by applying a braking force to a vehicle wheel by a brake device after the driver operates the brake pedal and by including a time immediately after the stop within a predetermined period of time after the vehicle stop time. In addition, in the present disclosure, the term “stop jerk” means a jerk phenomenon of a vehicle that occurs when stopped.

The reason that the ride comfort may be affected using the torque of the driving motor even when the vehicle is stopped and when the stop is completed by the brake system is that compliance is present in the chassis including a suspension and a driving system of the vehicle.

The chassis and the driving system of the vehicle are not formed of a rigid body. Bushings or clearances for allowing a relative movement between the parts are present in the chassis and the driving system. Thus, although a rotation of the vehicle wheel is stopped on the road surface, a slight rotation of the drive system or a movement of the suspension is allowed in the vehicle.

By using the above principle, when a movement within a compliance range opposite to a movement of a stop jerk is induced using the torque of the driving motor, the above two movements are offset.

The vehicle wheel (driving wheel) is connected to the driving motor in a manner such that power may be transferred from the driving motor to the vehicle wheel. Hereinafter, this may be referred to as the driving wheel being “power-transferably connected” to the driving motor. When the driving wheel is in a state of being stopped and becomes fixed on the road surface (stop completion state), a force due to a torque output from the driving motor may be transmitted to the vehicle body through a motor housing and may act as a force which may control a movement of the vehicle body.

In the present disclosure, the movement of the vehicle body due to the above force is generated to offset a stop jerk of the vehicle and is used to reduce the stop jerk. In this way, it is possible to eliminate a different feeling that the driver may feel or experience when stopped and, simultaneously, to improve ride comfort of the vehicle.

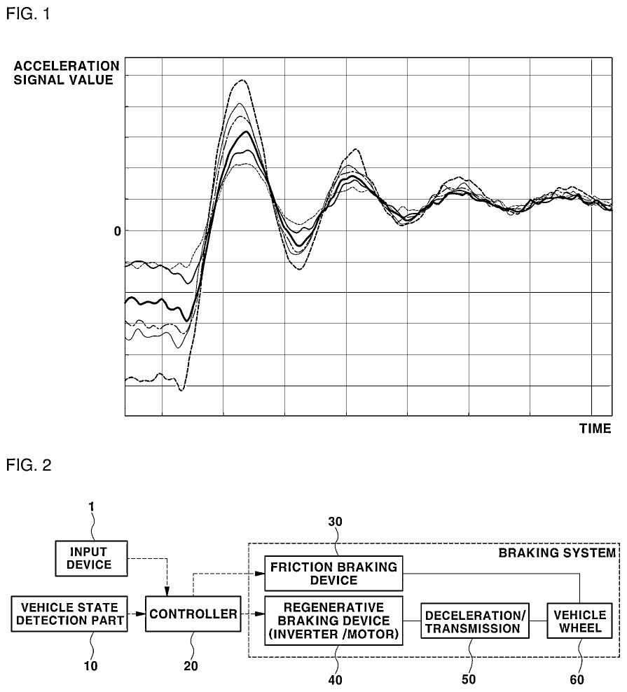

FIG. 1 is a graph showing a measured result of acceleration of a vehicle to indicate a jerk motion when stopped that shows a general jerk motion when stopped. In FIG. 1, a variation in acceleration signal appearing for a certain period of time immediately after the stop exhibits as a stop jerk.

The results of FIG. 1 are values measured by a longitudinal acceleration sensor mounted on the vehicle and show measured results when braking strength of drivers vary.

The acceleration sensor is a sensor for detecting acceleration of the vehicle and is configured to output an electrical signal according to a detected acceleration value. In the vehicle, a general acceleration sensor means a longitudinal acceleration sensor. An electrical signal output from the acceleration sensor, i.e., an acceleration signal, becomes a signal indicating longitudinal acceleration of the vehicle (longitudinal acceleration signal).

In the following description, acceleration means the longitudinal (i.e., forward and rearward) acceleration of the vehicle unless otherwise defined, and the acceleration sensor means a longitudinal acceleration sensor already installed in the vehicle. In addition, the acceleration signal means the electrical signal output from the acceleration sensor that becomes a signal indicating a longitudinal acceleration detection value of the vehicle.

Braking strength of the driver means a pedal operation state of the driver, such as an amount of a brake pedal operation (a brake pedal input value). FIG. 1 shows an acceleration signal measured when stopped in braking situations in which the driver changes operation states of the brake pedal.

The various braking situations in FIG. 1 are tested only with the braking strength and the braking force being different but all other vehicle conditions are the same. In particular, the same vehicle load was applied in all the braking situations. In other words, acceleration signals were measured by varying only the braking strength and the braking force in each braking situation in the same vehicle weight condition.

Referring to FIG. 1, even when the braking strength of the driver varies, when a vehicle condition such as a vehicle weight is the same, it can be seen that vibration periods of the acceleration signals generated when stopped are the same. However, as shown in FIG. 1, amplitudes of the acceleration signals are different as the braking strength of the driver varies.

When there is no change in vehicle conditions as shown in the measured results, even when the braking strength greatly differs, the acceleration signals when stopped differ only in amplitude, and the periods of the acceleration signals are the same. Therefore, when a driving motor torque is controlled by generating a periodic torque command to offset the stop jerk based on information on the acceleration signal obtained through the acceleration sensor when the vehicle is stopped, the stop jerk may be offset and reduced.

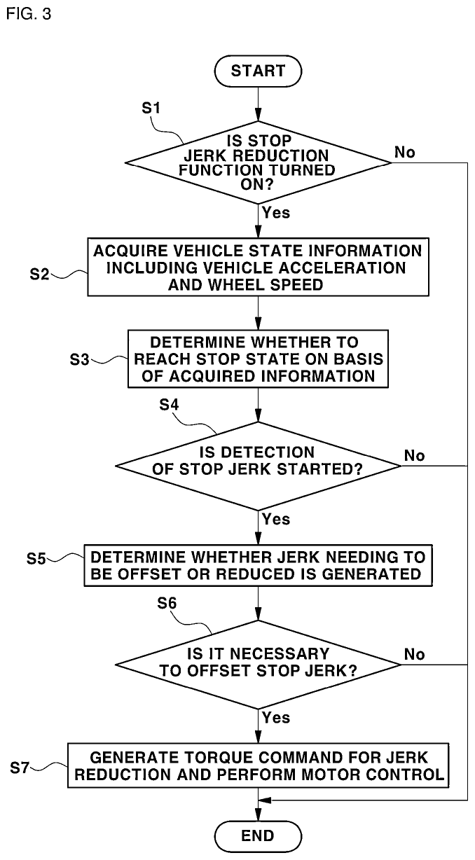

FIG. 2 is a block diagram illustrating a configuration of an apparatus for performing jerk reduction according to an embodiment of the present disclosure. FIG. 3 is a flowchart illustrating a process of controlling performance of the stop jerk reduction according to an embodiment of the present disclosure.

An apparatus for performing a control process according to an embodiment of the present disclosure includes a vehicle state detection part 10 configured to detect vehicle state information including vehicle acceleration, a controller 20 configured to generate and output a torque command for offsetting a vehicle jerk (stop jerk) based on the vehicle acceleration information detected by the vehicle state detection part 10, and a driving motor configured to generate and output a torque for jerk reduction to offset the vehicle jerk when the vehicle is stopped according to the torque command output from the controller 20.

In addition, the apparatus for performing a control process according to an embodiment of the present disclosure further includes an input device 1 provided to allow the driver to operate to selectively turn a stop jerk reduction function on or off.

In the present disclosure, the input device 1 may be a button or a switch installed in the vehicle and is provided to be communicatable in the controller 20 to input an ON signal and an OFF signal according to an operation of the driver when the ON or OFF operation is performed by the driver.

Accordingly, when the driver turns on the input device 1, such as a button or switch, the controller 20 may recognize that the stop jerk reduction function is turned on. As shown in FIG. 3, the controller 20 checks a state whether a stop jerk reduction function is turned on (S1) and performs a control process (S2 to S7) of reducing stop jerk reduction only in a state in which the stop jerk reduction function is turned on.

In other words, the stop jerk reduction function may be performed under the control of the controller 20 only when the stop jerk reduction function is turned on by the driver. The performing of the stop jerk reduction function means that the control process for stop jerk reduction according to the present disclosure is performed.

The vehicle state detection part 10 may include an acceleration sensor configured to detect vehicle acceleration, a brake pedal sensor (BPS) configured to detect a brake pedal input value, a rotation speed detector configured to detect a speed of the driving system, and/or a vehicle speed detector configured to detect a vehicle speed. In addition to the above components, the vehicle state detection part 10 may further include a gear stage detector configured to detect whether a current gear stage is a forward stage (D gear stage) or a backward stage (R gear stage).

In this case, the vehicle state information includes the vehicle acceleration detected by the acceleration sensor, the brake pedal input value detected by the BPS, the speed of the driving system detected by the rotation speed detector, the vehicle speed detected by the vehicle speed detector, and gear stage information detected by the gear stage detector.

The BPS is installed in the brake pedal to detect a brake pedal input value, i.e., a brake pedal operation state by the driver.

In addition, the speed of the drive system is a rotation speed of a vehicle driving system and may include a rotation speed of the driving motor (i.e., a motor speed) and a rotation speed (i.e., a wheel speed and a driving wheel speed) of a vehicle wheel 60 power-transferably connected to the driving motor.

In this case, the rotation speed detector may include a motor speed sensor configured to detect the rotation speed of the driving motor and a wheel speed sensor configured to detect the rotation speed of a driving wheel (i.e., a driving wheel speed). The driving wheel is the vehicle wheel 60 power-transferably connected to the driving motor. The motor speed sensor may be a conventional resolver installed in the driving motor to detect a rotor position of the driving motor.

The vehicle speed detector configured to detect the vehicle speed may also include a wheel speed sensor. Since obtaining real-time vehicle speed information from a signal of the wheel speed sensor is a well-known technique in the art, a detailed description thereof has been omitted herein.

The driving motor is a driving device (a driving source) for driving a vehicle and is a motor that is power-transferably connected to a driving wheel of the vehicle wheels 60. In a typical electric vehicle, the driving motor operates by receiving power from a battery (not shown).

The battery is connected to the driving motor to be charged and discharged 4 via an inverter. The inverter drives and controls the driving motor according to a torque command output from the controller 20.

In a typical electric vehicle, a torque output from the driving motor is transmitted to the vehicle wheel 60 through the vehicle drive system such as a reducer 50. When the vehicle wheel 60 is stopped and becomes fixed on a road surface after the vehicle is stopped, the torque output from the driving motor and transmitted to the vehicle body may offset a stop jerk of the vehicle when stopped.

The inverter and the driving motor are used not only as the driving device of the vehicle but also as a regenerative braking device 40 configured to apply a braking force to the vehicle wheel (driving wheel) 60. The regenerative braking device 40 applies an electric braking force (regenerative braking force) by the driving motor to the vehicle wheel 60 and constitutes a braking system of the vehicle together with a friction braking device 30 configured to generate and apply a friction braking force.

In the vehicle, the vehicle wheel 60 to which the regenerative braking force is applied by the regenerative braking device 40 is a driving wheel power-transferably connected to the driving motor. For example, the driving wheel may be a rear wheel of the vehicle. In this case, the vehicle wheel 60 to which the friction braking force is applied by the friction braking device 30 may be a driving wheel or a driven wheel (non-driving wheel) other than the driving wheel.

In embodiments of the present disclosure, in a state in which the stop jerk reduction function is turned on, the controller 20 receives vehicle state information detected by the vehicle state detection part 10. In other words, the controller 20 acquires information or data on the vehicle acceleration, the brake pedal input value, the speed of the driving system, the vehicle speed, and the gear stage which are respectively detected by the acceleration sensor, the brake pedal sensor, the rotation speed detector, the vehicle speed detector, and the gear stage detector (S2 of FIG. 3).

In addition, the controller 20 determines whether a current vehicle state reaches a stop completion state after deceleration based on the vehicle state information detected by the vehicle state detection part 10 (S3 of FIG. 3). When it is determined that the vehicle reaches the stop completion state, the controller 20 generates and outputs a torque command for offsetting a stop jerk of the vehicle when stopped based on the vehicle acceleration information from a point of time when the stop is completed.

In the present disclosure, in order to implement control for reducing a jerk occurring when the vehicle is stopped, i.e., a stop jerk, a jerk occurring immediately after the stop from a point of time when the vehicle is stopped after the vehicle is decelerated and stopped should be analyzed. In addition, in order to analyze the above jerk, it may be necessary to determine whether the current vehicle state is a stop completion state in which the vehicle is definitely stopped.

The determination of the stop completion state may be performed by the controller 20 or may be performed by the controller 20 using the vehicle state information detected by the vehicle state detection part 10.

In addition to the above description, the determination of the stop completion state may be performed by the controller 20 using the vehicle state information detected by the above-described sensors, observation information or command information obtained based on information or data of other sensors of the vehicle state detection part 10, or values (such as values obtained by filtering sensor values) derived from the above-described pieces of information.

Alternatively, the determination of the stop completion state in the controller 20 may be performed using at least two among the vehicle state information, the observation information, the command information, and the values derived therefrom.

The command information may be a torque command, and specifically, a motor torque command, which is determined based on real-time vehicle driving information. The motor torque command may be determined by the controller 20. In this case, the controller 20 may be a vehicle controller (a vehicle control unit (VCU)) configured to determine the motor torque command based on the real-time vehicle driving information in a typical electric vehicle.

A process or a method of determining the motor torque command based on the real-time vehicle driving information is a well-known technical matter, and thus a detailed description thereof has been omitted herein.

In the embodiments of the present disclosure, the controller 20 may monitor one or two or more pieces of information or data sets among the vehicle state information, the observation information, the command information, and the values derived therefrom in real time. The controller 20 may selectively use information including the monitored current values, inclinations of the values, and inflection points of the values and may check whether each of the current value, the inclination of the value, and the inflection point of the value satisfies a preset reference value condition. Whether the current vehicle state reaches the stop completion state after the deceleration may thereby be determined.

In this case, when a set stop state enable condition is satisfied, the controller may be set to determine that the current vehicle state reaches the stop completion state after the deceleration.

For example, the stop state enable condition may include: a first condition in which the brake pedal input value is greater than or equal to a predetermined pedal input reference value; a second condition in which the driving wheel speed (wheel speed) is less than or equal to a predetermined speed reference value; a third condition in which an upward inclination of acceleration is in a state of rapidly rising a predetermined inclination reference value or more; a fourth condition after occurrence of a micro-reverse rotation state of the driving motor in which the driving motor speed is in a negative (−) speed state in which the gear stage is at a forward stage that is a forward (D) stage; and a fifth condition in which the vehicle speed has a history of reaching a predetermined reference speed after a previous stop state enable condition satisfaction state is released (deactivated).

In addition, only when an elapsed time of a state in which all of the first to fifth conditions are satisfied is within a predetermined set time (e.g., two seconds), the controller 20 may be set to determine that the stop state enable condition is satisfied.

As described above, when it is determined that the current state reaches the stop completion state, the controller 20 starts to detect the stop jerk (S4 of FIG. 3). When the detection of the stop jerk is started, the controller 20 checks whether a stop jerk that needs to be offset or reduced occurs based on the information acquired from the vehicle and determines whether the stop jerk needs to be or should be offset or reduced (S5 of FIG. 3).

In addition, as the determination result, when it is necessary or desired to offset and reduce the stop jerk (S6 of FIG. 3), the controller 20 determines, generates, and outputs a torque command for jerk reduction to offset and reduce the stop jerk from the acceleration signal (S7 of FIG. 3).

Thus, an operation of the driving motor is controlled according to the torque command for jerk reduction output from the controller 20 (S7 of FIG. 3). Eventually, the driving motor outputs a torque for jerk reduction so that, due to the torque for jerk reduction output from the driving motor, the stop jerk occurring when the vehicle is stopped may be offset and reduced.

As described above, when it is determined that the vehicle actually reaches a complete stop state (the stop completion state), even when the stop jerk occurs, an operation is performed to determine whether the stop jerk is a target to be offset or reduced is necessary or desired. This is because, in some cases, even when the vehicle reaches the stop completion state, the stop jerk occurs quite weakly so that there may be a case in which a separate action is unnecessary or not desired.

Similar to the determination of the stop completion state, the determination of whether the stop jerk needs to be offset and reduced (S5) may also be performed by the controller 20 using the vehicle state information detected by the vehicle state detection part 10. In addition to the above description, the determination of the stop completion state may be performed by the controller 20 using the vehicle state information, the observation information or the command information, which is obtained based on pieces of information of other sensors, or the values (such as values obtained by filtering sensor values) derived therefrom.

Alternatively, the determination of whether the stop jerk needs to be offset and reduced in the controller 20 may be performed using at least two among the vehicle state information, the observation information, the command information, and the values derived therefrom.

In other words, the controller 20 may monitor one or two or more pieces of information or data sets among the vehicle state information, the observation information, the command information, and the values derived therefrom in real time. The controller 20 may selectively use information including the monitored current values, inclinations of the values, and inflection points of the values and check whether each of the current value, the inclination of the value, and the inflection point of the value satisfies a preset reference value condition, thereby determining whether the stop jerk needs to be offset and reduced. Another value separately set from the reference value for determining the vehicle stop completion state may be used as the reference value.

In this case, when a set stop jerk offset condition is satisfied, the controller 20 may be set to determine that a current stop jerk needs to be offset and reduced. By stating herein that stop jerk offset “needs” to be addressed or is “necessary” it is meant that the stop jerk is analyzed and determined to meet or surpass a certain threshold or reference value.

For example, the stop jerk offset condition may include: a sixth condition in which the brake pedal input value is greater than or equal to the predetermined pedal input reference value; a seventh condition in which the driving wheel speed (wheel speed) is less than or equal to the predetermined speed reference value; an eighth condition in which an upward inclination of acceleration is in a state of rapidly rising the predetermined inclination reference value or more; a ninth condition after occurrence of a micro-reverse rotation state of the driving motor in which the driving motor speed is in a negative (−) speed state in which the gear stage is at a forward stage that is a D stage; and a tenth condition in which the vehicle speed has a history of reaching a predetermined reference speed after a previous stop jerk necessary condition satisfaction state is released (deactivated).

In addition, only when an elapsed time of a state in which all of the sixth to tenth conditions are satisfied is within a predetermined set time, the controller 20 may be set to finally determine that the stop jerk necessary condition is satisfied.

A reference value in each of the sixth to tenth conditions may be a different value determined separately from each reference value in the first to fifth conditions. Also, the set time, which is separately determined and is different from the set time when the determining of the vehicle stop completion state, may be used.

In addition, when it is determined that the stop jerk needs to be or should be offset and reduced, the controller 20 analyzes the vehicle acceleration information acquired by the acceleration sensor to determine, generate, and output a command for generating a torque for stop jerk reduction, i.e., a torque command for jerk reduction (S7).

More specifically, the torque command for jerk reduction may be determined by the controller 20 based on the acceleration signal input from the acceleration sensor. A filter or a transfer function is applied to the acceleration signal to remove a noise.

In this case, a preset value is used as a natural frequency characteristic of the applied filter. Since the natural frequency characteristic of the filter has a vehicle-specific characteristic, which is clearly determined by a characteristic of a chassis including the suspension of the vehicle, a significant change factor is not present, excluding a variation in weight of the vehicle. See the measured value of the actual vehicle in FIG. 1 whereby it may be seen that the natural frequency is clean and distinct and does not change.

Moreover, since a natural frequency characteristic of a stop jerk inducible by the variation in weight of the vehicle is within a maximum of 1.5 times, a strategy of setting a value of the natural frequency characteristic in advance is effective. In this way, a noise may be effectively removed through the torque command for jerk reduction. When this is greater than or equal to 1.5 times, a problem of exceeding an allowable vehicle load occurs.

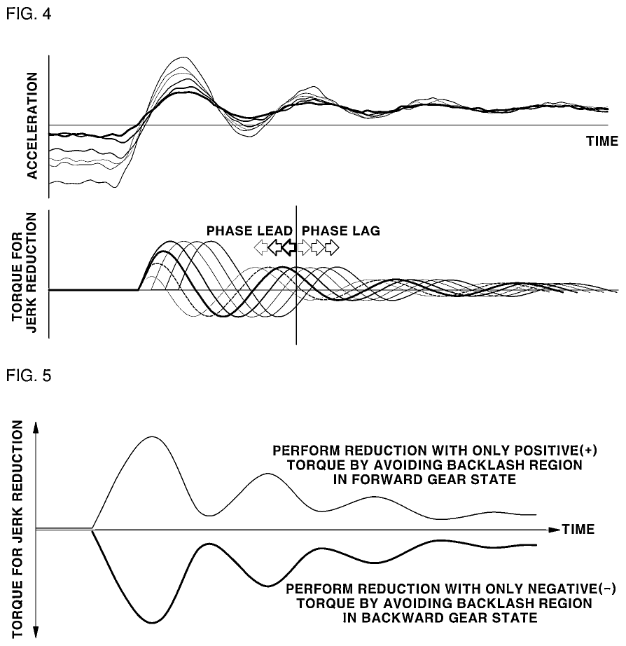

FIG. 4 is a diagram illustrating a stop jerk and a torque for jerk reduction in the present disclosure that shows phase adjustment applicable to the torque for jerk reduction, which is a compensation torque for jerk offset, for an offset effect of the stop jerk.

As shown in FIG. 4, the torque command for jerk reduction generated and determined by the controller 20 may have the same period as the acceleration signal of the acceleration sensor. In addition, the controller 20 may determine and generate a lead or lag torque command for jerk reduction, the phase of which is adjusted by as much as a phase value, which is set to the acceleration signal of the acceleration sensor. In this case, the phase value used for the phase adjustment may be a value that is preset in the controller 20.

In the present disclosure, a transfer function between a measured acceleration value and a jerk, which actually occurs, may be different for each vehicle type. Thus, in order to set an optimal phase value, a phase value with which a stop jerk offset effect is maximized may be derived and determined through a previous evaluation and a test process in the development stage of the same type of vehicle.

In addition, the determined phase value may be input, stored, and set in a controller 20 of an actually applied target vehicle in advance and then, in the process of driving the vehicle, the controller 20 may use the set phase value.

In other words, the controller 20 determines the torque for jerk reduction, which is capable of offsetting and reducing the stop jerk, from the acceleration signal indicating the stop jerk using the set phase value, i.e., the torque for jerk reduction having a phase adjusted by as much as the phase value and outputs the torque command for jerk reduction, which is a command for generating the finally determined torque for jerk reduction.

The above-described noise removal, extraction of a jerk component reflecting the natural frequency characteristic and setting of the phase value may be calculated by applying a filter or a transfer function to the measured acceleration information.

The transfer function may be a function in the form of a Laplace function. According to a coefficient value of the transfer function, which is set when applied, a frequency characteristic and a phase characteristic of an extracted output waveform may be determined.

In addition, as described above, the result value output by passing through the filter or transfer function may be used as the torque command for jerk reduction. To this end, it is necessary to perform setting a coefficient of the transfer function to allow the natural frequency characteristic of the output result value to include a frequency characteristic of a unique stop jerk of a corresponding vehicle type. In addition, it is necessary to perform setting a coefficient of the transfer function to have a phase value with which the jerk offset effect is maximized for each vehicle type.

For example, when a transfer function and a coefficient thereof are set based on a second-order low-pass filter (LPF), a transfer function such as the following Equation 1 may be used. In the following transfer function, since a characteristic of a filter output value varies according to set values of coefficients such as ω0 and Q, a value of ω0 should be set to be similar to the natural frequency value of the stop jerk. In addition, it is necessary to perform a setting process of allowing a combination of wo and Q to have a valid phase to offset the stop jerk.

$${H}_{LP} ( S ) = \frac{{ω}_{0}^{2}}{{S}^{2} + ( {ω}_{0} / Q ) S + {ω}_{0}^{2}} \qquad [ Equation 1 ]$$

The present inventor operated the driving motor when an actual vehicle in which the braking device was operated was in a stopped state to allow the driving motor to output a driving force (a motor torque). The present inventor measured vehicle acceleration generated when the driving force was applied using the acceleration sensor.

In addition, the present inventor analyzed the jerk occurring when the vehicle is stopped using the acceleration sensor in the actual vehicle. As the analysis result, it was confirmed that an amplitude of longitudinal acceleration when stopped was about 0.1 g-force (G).

In addition, it was confirmed that it was sufficient to generate, output, and apply a torque of about 40 Newton-meters (Nm) through the driving motor to generate an acceleration amplitude of about 0.1 G in a stopped state. Thus, it was confirmed that acceleration for jerk offset capable of sufficiently reducing a stop jerk was generated in the vehicle using only the torque command for jerk reduction, which had a small amplitude. In this way, the performance of the embodiments of the present disclosure were verified.

In addition, since the stop jerk offset process applied to improve riding comfort should not cause a jerk due to a backlash impact, torque control of the driving motor is performed by generating a torque command for jerk reduction out of a backlash torque range not to cause a backlash.

FIG. 5 is a diagram illustrating an example of the torque command for jerk reduction to which an amplitude and an offset are applied to avoid a backlash torque region according to a gear stage state. As shown in the drawing, the torque command for jerk reduction is generated in the form of a command having an offset capable of avoiding the backlash torque region.

Generally, in the torque of the driving motor, the backlash torque region capable of causing a backlash is a region in the vicinity of zero torque and may be a torque range including the zero torque. Therefore, the torque command for jerk reduction should be determined to have all of the command values other than the zero torque and should be determined to have all of the command values out of the backlash torque range.

When the torque command for jerk reduction is determined, the controller 20 may be set to determine the torque command for jerk reduction in consideration of an amplitude and an offset for preventing all of the command values from being included in the backlash torque region.

In addition, when the brake pedal is released, a different feeling may be generated due to a torque for residual jerk reduction. Therefore, it is desirable to perform stop jerk reduction control so that the torque for residual jerk reduction may have the same effect as a creep torque.

In other words, as shown in FIG. 5, when the gear stage is in a state of a forward stage (drive or D gear stage), the controller 20 applies a torque offset in a positive (+) direction, thereby determining an entirety of a torque command for jerk reduction, which has a positive (+) value out of the backlash torque range.

In addition, when the gear stage is in a state of a backward stage (reverse or R gear stage), the controller 20 applies a torque offset in a negative (−) direction, thereby determining an entirety of a torque command for jerk reduction, which has a negative (−) value out of the backlash torque range.

In addition, when the stop jerk is sufficiently attenuated and the offset and reduction of the stop jerk should be terminated, the controller 20 gradually decreases a corresponding offset to gradually converge the torque command for jerk reduction to zero.

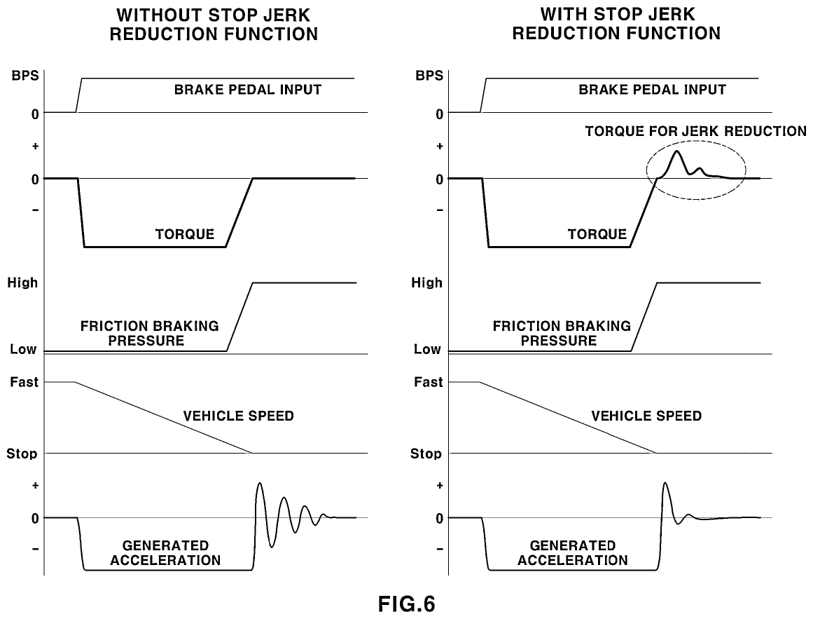

FIG. 6 is a diagram illustrating an example of a jerk reduction effect when a stop jerk reduction function is applied according to the present disclosure. A “friction braking pressure” is a value corresponding to the friction braking force applied to the vehicle wheel 60, and “generated acceleration” indicates the acceleration signal and is vehicle acceleration measured by the acceleration sensor.

After the brake pedal is actuated or brake pressure is input, a friction braking force is applied to the vehicle wheel 60, and thus the vehicle speed is gradually reduced. When the vehicle is decelerated and the vehicle reaches a complete stop state, i.e., a stop completion state, a variation in vehicle acceleration having a period and an amplitude occurs.

As shown in FIG. 6, when the stop jerk reduction function according to the present disclosure is not applied, the variation in vehicle acceleration occurs for a relatively long period of time. On the other hand, when the stop jerk reduction function according to the present disclosure is applied, the torque for jerk reduction is applied to the vehicle through the driving motor so that the stop jerk, which is the variation in vehicle acceleration, may be offset and reduced due to the torque for jerk reduction.

Therefore, when the stop jerk reduction function according to the present disclosure is applied, the stop jerk can be effectively reduced and attenuated within a shorter time, and ride comfort of the vehicle can be improved.

In accordance with an apparatus and a method for reducing a stop jerk according to the present disclosure, a method of applying a torque for jerk reduction capable of offsetting a stop jerk within a compliance range of a chassis and a driving system of a vehicle is employed using a driving motor with excellent control responsiveness in an electrified vehicle. According to the disclosed method and apparatus, more effective and superior jerk reduction performance can be provided only by adding a simplified control logic for generating a torque command for jerk reduction and controlling an operation of the driving motor according to the generated torque command for jerk reduction without additional hardware, cost increase, or a side effect of the performance.

Although the embodiments of the present disclosure have been described in detail, the scope of the prevent disclosure is not limited to these embodiments. Various modifications and improvements devised by those having ordinary skill in the art using the fundamental concept of the present disclosure, which is defined by the appended claims, further fall within the scope of the present disclosure.

What is claimed is:

1. A method of reducing a stop jerk of an electric vehicle, the method comprising:
acquiring, by a controller, vehicle state information through a vehicle state detection part;
determining, by the controller, whether a vehicle reaches a stop completion state after deceleration based on the acquired vehicle state information;
when the controller determines that the vehicle reaches the stop completion state, determining and generating a torque command for jerk reduction to offset and reduce a vehicle jerk immediately after the stop based on vehicle acceleration information detected by an acceleration sensor of the vehicle state detection part, and
controlling, by the controller, an operation of a driving motor according to the generated torque command for jerk reduction and offsetting and reducing the vehicle jerk due to a torque output from the driving motor and applied to the vehicle.

2. The method of claim 1, wherein, in the determining of whether the vehicle reaches the stop completion state, the controller determines whether a preset stop state enable condition is satisfied based on the acquired vehicle state information and wherein, when the preset stop state enable condition is satisfied, the controller determines that a current vehicle state reaches the stop completion state after the deceleration.

3. The method of claim 2, wherein the stop state enable condition includes:
a first condition in which a brake pedal input value is greater than or equal to a predetermined pedal input reference value;
a second condition in which a wheel speed of a driving wheel is less than or equal to a predetermined speed reference value;
a third condition in which an upward inclination of acceleration is in a state of rapidly rising a predetermined inclination reference value or more;
a fourth condition after occurrence of a micro-reverse rotation state of the driving motor in which a driving motor speed is in a negative (−) speed state in which a gear stage is at a forward D stage; and
a fifth condition in which the vehicle speed has a history of reaching a predetermined reference speed after a previous stop state enable condition satisfaction state is released.

4. The method of claim 3, wherein, only when an elapsed time of a state in which all of the first to fifth conditions are satisfied is within a predetermined set time, the controller determines that the stop state enable condition is satisfied.

5. The method of claim 1, wherein, in the determining and generating of the torque command for jerk reduction, the controller applies a filter or a transfer function for noise removal to an acceleration signal input from the acceleration sensor to generate the torque command for jerk reduction.

6. The method of claim 5, wherein the filter or the transfer function having a natural frequency characteristic of a preset value is used in the controller.

7. The method of claim 6, wherein:
the controller uses a result value output through the filter or the transfer function as the torque command for jerk reduction; and
the filter or the transfer function is configured to output the result value having a natural frequency characteristic including a frequency characteristic of a vehicle jerk, unique to a corresponding vehicle type, immediately after the stop.

8. The method of claim 1, wherein, in the determining and generating of the torque command for jerk reduction, a lead or lag torque command for jerk reduction is determined and generated, the phase of the lead or lag torque command being adjusted by a preset phase value with respect to the acceleration signal input from the acceleration sensor.

9. The method of claim 8, wherein the torque command for jerk reduction is determined and generated to have the same period as the acceleration signal.

10. The method of claim 8, wherein the phase value is set in the controller as a phase value of the torque command for jerk reduction, which maximizes an offset effect of the vehicle jerk immediately after the stop through a preceding test and an evaluation process with respect to the same vehicle type.

11. The method of claim 8, wherein the torque command for jerk reduction is determined and generated as a value out of a preset backlash torque range in a torque range including a zero torque.

12. The method of claim 11, wherein, when a current gear stage is a forward stage, the torque command for jerk reduction is determined by applying a torque offset to the acceleration signal in a positive (+) direction so that all command values have positive (+) values.

13. The method of claim 11, wherein, when a current gear stage is a backward stage, the torque command for jerk reduction is determined by applying a torque offset to the acceleration signal in a negative (−) direction so that all command values have negative (−) values.

14. The method of claim 11, wherein the torque command for jerk reduction is determined by applying a torque offset to the acceleration signal, and with the passage of time, the torque offset gradually decreases and the command value gradually converges to zero.

15. An apparatus for reducing a stop jerk of an electric vehicle, the apparatus comprising:
a vehicle state detection part configured to detect vehicle state information;
a controller configured to, when it is determined that a vehicle reaches a stop completion state after the vehicle is decelerated based on the vehicle state information acquired through the vehicle state detection part, determine and generate a torque command for jerk reduction to offset and reduce a vehicle jerk immediately after the stop based on vehicle acceleration information detected by an acceleration sensor of the vehicle state detection part; and
a driving motor configured to be operated according to the torque command for jerk reduction output from the controller and configured to output a torque for offsetting and reducing the vehicle jerk and apply the torque to the vehicle.

16. The apparatus of claim 15, wherein the controller is set to determine and generate a lead or lag torque command for jerk reduction, the phase of which is adjusted by a preset phase value with respect to the acceleration signal input from an acceleration sensor.

17. The apparatus of claim 16, wherein the torque command for jerk reduction is determined and generated as a value out of a preset backlash torque range in a torque range including a zero torque.

18. The apparatus of claim 17, wherein, when a current gear stage is a forward stage, the torque command for jerk reduction is determined by applying a torque offset to the acceleration signal in a positive (+) direction so that all command values have positive (+) values.

19. The apparatus of claim 17, wherein, when a current gear stage is a backward stage, the torque command for jerk reduction is determined by applying a torque offset to the acceleration signal in a negative (−) direction so that all command values have negative (−) values.

20. The apparatus of claim 15, wherein the acceleration sensor includes a longitudinal acceleration sensor configured to detect longitudinal acceleration of the vehicle and output an acceleration signal, which is an electrical signal according to the detected value.
